(19) United States
(12) Patent Application Publication
(10) Pub. No.: US 2014/0181176 A1
(43) Pub. Date: Jun. 26, 2014

(54) GRAPHICAL USER INTERFACE FOR HADOOP SYSTEM ADMINISTRATION

(71) Applicants: Kumar Swamy B.V., Bangalore (IN); W. Michael Rist, Roseville, MN (US); Waldyn Benbenek, Roseville, MN (US)

(72) Inventors: Kumar Swamy B.V., Bangalore (IN); W. Michael Rist, Roseville, MN (US); Waldyn Benbenek, Roseville, MN (US)

(73) Assignee: Unisys Corporation, Blue Bell, PA (US)

(21) Appl. No.: 13/721,304

(22) Filed: Dec. 20, 2012

(51) Int. Cl. H04L 29/08

(52) U.S. Cl. CPC H04L 67/10
USPC 709/203

(57) ABSTRACT

Systems and methods are described herein for administration of a Hadoop distributed computing network. The described embodiments include a graphical user interface (GUI) that facilitates administration and setup of a Hadoop system by removing the need for the administrator to enter complicated commands via a command line interface. The GUI also provides a visual indicator of the setup progress of the Hadoop system, among other benefits.

### FIELD OF THE INVENTION

The present invention relates generally to distributed data storage and processing computer systems and more particularly to a graphical user interface for such systems.

### BACKGROUND

A Hadoop computing framework, such as Apache™ Hadoop®, allows storage and processing of large data sets spread among a plurality of computers using a distributed computing paradigm in the context of data and content management. The distributed nature of the Hadoop system pools computational and data storage resources across multiple computer servers, each with its own processor and memory hardware. This decreases computational load associated with performing processing (e.g., data base and/or application related processing) on large data sets and increases overall system availability.

To administer and set up a Hadoop system, the system administrator relies on native Linux Command Line Interface (CLI) commands. This requires specific knowledge of complex command syntax, increases potential for user error, and generally increases the time investment needed to administer a large number of Hadoop system components.

### SUMMARY

in various embodiments, a system and method are provided for administration of a Hadoop distributed computing network. The described embodiments include a graphical user interface (GUI) that facilitates administration and setup of a Hadoop system by removing the need for the administrator to enter complicated commands via a command line interface. The GUI also provides a visual indicator of the setup progress of the Hadoop system, among other benefits.

in one embodiment, a system is provided for administration of a Hadoop distributed computing network. The system comprises a Hadoop cluster including at least one name node computer and a plurality of data node computers. In an embodiment, the system further includes a secondary name node computer for Hadoop High Availability. The system further includes an administration computer comprising a processor and computer readable memory having stored thereon computer executable instructions for implementing a Hadoop adapter configured to receive user input and convert the user input into computer executable instructions for administering the Hadoop cluster. The system also includes a graphical user interface configured to provide said user input to the Hadoop adapter of the administration computer. The graphical user interface comprises an inventory module configured to receive the user input for administering the Hadoop cluster, a configuration module configured to communicate the computer executable instructions for administering the Hadoop cluster to at least one of the name node computer, the secondary name node computer, and one or more data node computers and provide a visual indication of a configuration status of the at least one of the name node computer, the secondary name node computer, and the one or more data node computers, and an administration module configured to provide status with respect to one or more computer executable processes associated with the Hadoop cluster.

In another embodiment, a method is provided for administering a Hadoop distributed computing network via a computer implemented graphical user interface. The method comprises receiving, via the computer implemented graphical user interface, user input for administering a Hadoop cluster comprising a name node computer, the secondary name node computer, and a plurality of data node computers. The method further comprises transforming the user input into computer executable instructions for administering the Hadoop cluster and storing said instructions in a non-transitory computer readable medium, The method also includes communicating the computer executable instructions for administering the Hadoop cluster to at least one of the name node computer, the secondary name node computer, and one or more data node computers, providing, via the computer implemented graphical user interface, a visual indication of a configuration status of the at least one name node computer, the secondary name node computer, and the one or more data node computers. The method further includes providing, via the computer implemented graphical user interface, a status with respect to one or more computer executable processes associated with the Hadoop cluster.

In yet another embodiment, a non-transitory computer readable medium is provided having stored thereon computer executable instructions for administering a Hadoop distributed computing network via a graphical user interface. The instructions comprise receiving user input for administering a Hadoop cluster comprising a name node computer, a secondary name node computer, and a plurality of data node computers, transforming the user input into computer executable instructions for administering the Hadoop cluster, and communicating the computer executable instructions for administering the Hadoop cluster to at least one of the name node computer, the secondary name node computer, and one or more data node computers. The instructions further comprise providing a visual indication of a configuration status of the at least one name node computer, the secondary name node computer, and the one or more data node computers, and providing a status with respect to one or more computer executable processes associated with the Hadoop cluster.

Additional features and advantages of embodiments will be set forth in the description which follows, and in part will be apparent from the description. The objectives and other advantages of the invention will be realized and attained by the structure particularly pointed out in the exemplary embodiments in the written description and claims hereof as well as the appended drawings. It is to be understood that both the foregoing general description and the following detailed description are exemplary and explanatory and are intended to provide further explanation of the invention as claimed.

### BRIEF DESCRIPTION OF THE DRAWINGS

The accompanying drawings constitute a part of this specification and illustrate an embodiment of the invention and together with the specification, explain the invention.

FIG. 1 illustrates a schematic diagram illustrating a system environment of a Hadoop distributed storage system according to an exemplary embodiment.

FIG. 2 illustrates a schematic diagram illustrating a GUI screen associated with the inventory module of the Hadoop adapter of FIG. 1, according to an exemplary embodiment.

FIG. 3 illustrates a schematic diagram illustrating a GUI configuration screen associated with a configuration module of the Hadoop adapter of FIG. 1, according to an exemplary embodiment.

FIG. 4 illustrates a schematic diagram illustrating a GUI configuration screen associated with an administration module of the Hadoop adapter of FIG. 1, according to an exemplary embodiment.

### DETAILED DESCRIPTION

Various embodiments and aspects of the invention will be described with reference to details discussed below, and the accompanying drawings will illustrate the various embodiments. The following description and drawings are illustrative of the invention and are not to be construed as limiting the invention. Numerous specific details are described to provide a thorough understanding of various embodiments of the present invention. However, in certain instances, well-known or conventional details are not described in order to provide a concise discussion of embodiments of the present invention.

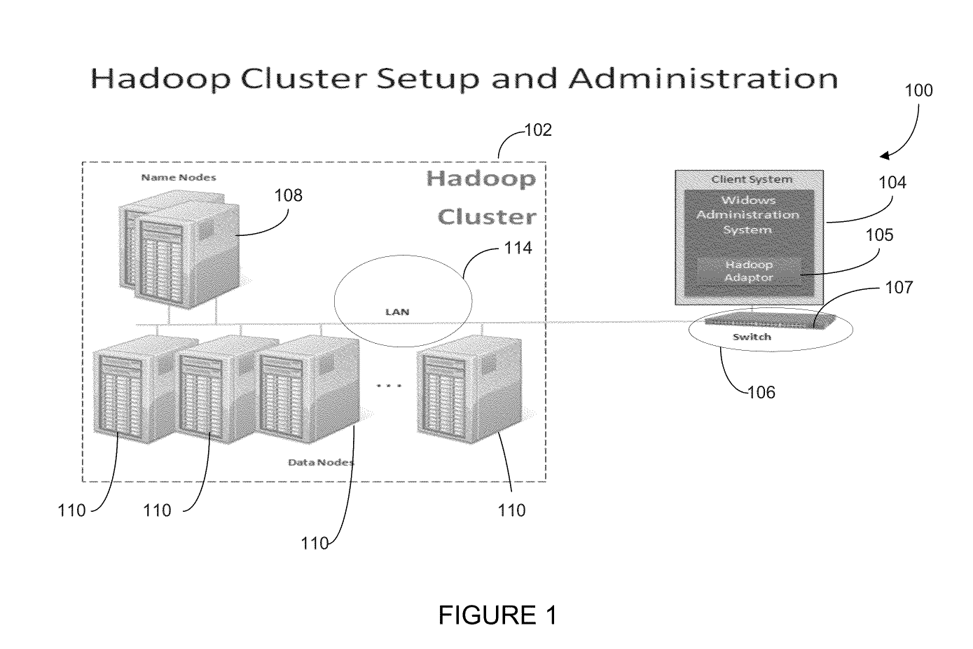

FIG. 1 illustrates a schematic diagram illustrating an embodiment of a system environment of a Hadoop distributed storage system 100. The Hadoop system 100 includes one or more Hadoop clusters 102 connected to the administration computer system 104 via a network 106. The administration computer system 104 manages and configures the Hadoop cluster 102, as further discussed below. The administration computer system 104 comprises one or more special purpose administrator computers comprising non-transitory computer readable memory storing computer executable instructions for presenting a graphical user interface to facilitate administration of the Hadoop system 100. The administration computer system 104 communicates with and administers the Hadoop cluster 102 via a Hadoop adapter 105, which comprises computer executable instructions compatible with the Hadoop application framework. In various embodiments, the network 106 comprises a Wide Area Network (WAN), including the Internet, or a Local Area Network (LAN), including a switch 107. The Hadoop cluster 102, in turn, includes a name node 108 and a plurality of data nodes 110. The data nodes 110 store data that is distributed and/or replicated across multiple data nodes. The name node 108 includes a directory tree of storage locations of all data in the Hadoop cluster 102. In response to requests for file operations from client computer 112, the name node 108 identifies the data nodes on which the requested data is stored to permit further interaction between the client computer 112 and the identified data nodes, including distributed processing of the underlying data among a plurality of data nodes. In an embodiment, the name node 108 and data nodes 110 are connected via a network 114, such as a LAN, WAN or the Internet.

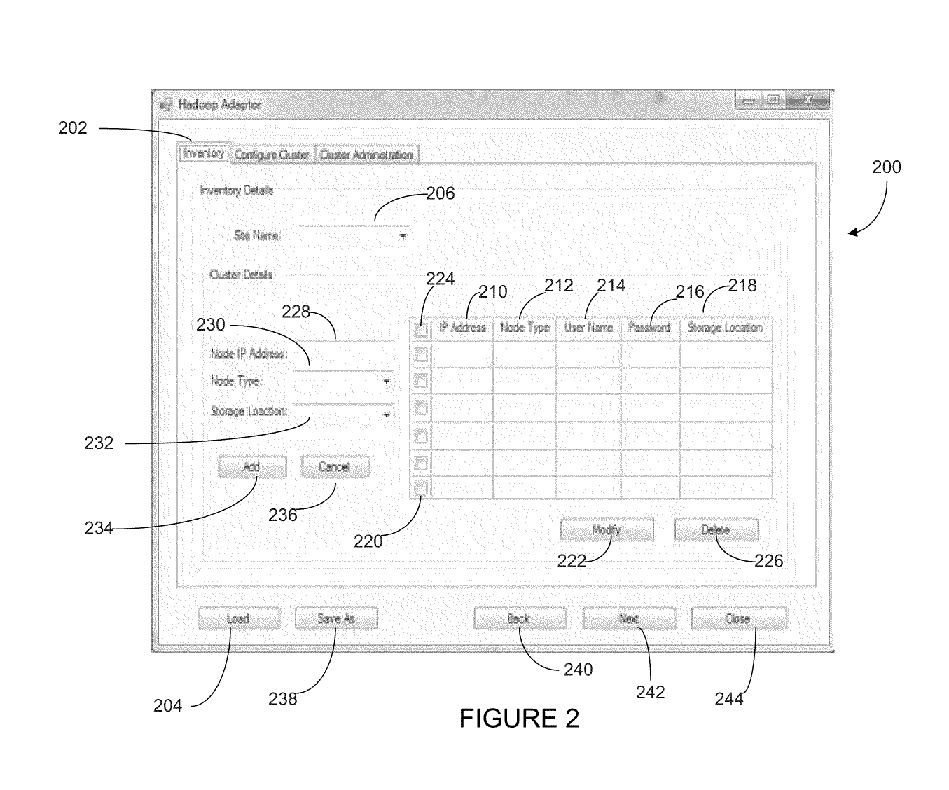

Referring to FIGS. 2-4, an embodiment of a graphic user interface for administering the Hadoop system 100 is shown. The graphical user interface (GUI) depicted in FIGS. 2-4 is implemented and displayed by one or more administrator computers of the administration computer system 104 specially programmed to execute, via a processor, instructions stored in its non-transitory computer readable memory, such as a hard drive, a flash memory, RAM, ROM, or the like. The Hadoop adaptor 105 (FIG. 1) receives user input from the GUI and converts said input into computer executable instructions having a format compatible with Hadoop application framework. Therefore, embodiments of the GUI of FIGS. 2-4 facilitate administration and setup of the Hadoop system 100 by removing the need. for the administrator to enter complicated commands via a command line interface and provide a visual indicator of the setup progress of the Hadoop system, among other benefits.

FIG. 2 illustrates an embodiment of the GUI screen 200 associated with the inventory module of the Hadoop adapter 105. The GUI screen 200 is user selectable via a tab 202 and includes an interface for loading, modifying, and creating the Hadoop cluster 102. For instance, when the user selects the load button 204, the screen 200 is populated with the details with respect to the configuration of a Hadoop cluster selected via the Site Name drop down list 206. The Site Name drop down list 206 includes a list of Hadoop cluster names comprising the loaded Hadoop system. When the user selects a particular site name, corresponding cluster details appear at the Cluster Details table 208. The Cluster Details table includes node-specific information fields, such as the node IP address 210, node type 212, and corresponding node's administrator user name and password 214, 216. The table 208 further includes a storage location field 218 corresponding to the storage location of the data in each node system. The node type field 212 notifies the user whether a particular node of the displayed cluster is a name node or a data node. In one embodiment, the user selects one or more selection boxes 220 and presses the modify button 222 in order to make the corresponding rows editable when the user desires to modify any of the fields 210-218. The user deletes the nodes displayed in the Cluster Details table 208 by selecting a delete button 226 after selecting one or more nodes via the corresponding selection boxes 220 or all nodes via the top-most selection box 224. The modify button 222 becomes disabled if more than one check box is selected.

The administrator adds a new node to the cluster by inputting a node IP address in the field 228 and selecting the node type (e.g., name node, secondary name node, or data node) via the node type drop down list 230. The user then indicates the storage location of the data in each node system via the storage location drop down list 232 and selects an add button 234 to add the new node to the Cluster Details table 208. In an embodiment, the storage location of the data may be the same for all nodes in the cluster. However, the drop down option 232 is provided so that the user can choose from the list of additional nodes for the data storage location. The cancel button 236, on the other hand, cancels user's inputs for adding a new node. When the user is finished modifying node information in the table 208 and/or adding a new node, the new cluster configuration is saved under a corresponding name by selecting the save as button 238. The back and next buttons 240-242 provide the navigation functionality among the various GUI screens discussed herein. Finally, the close button 244 closes the Hadoop adapter GUI interface.

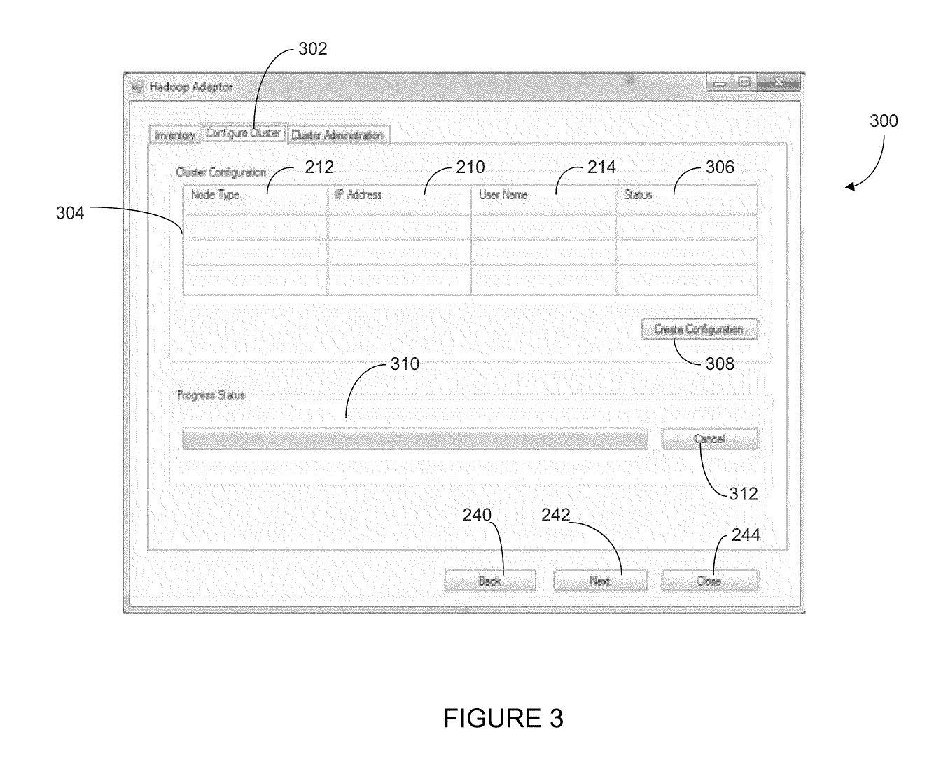

FIG. 3 illustrates an embodiment of a GUI configuration screen 300 associated with a configuration module of the Hadoop adapter 105. The configuration module communicates Hadoop framework specific commands, including associated parameters, for initiating a configuration of the nodes within the cluster 102 and receives configuration acknowledgments from the nodes upon completion of specified configuration commands. The user navigates to the configuration screen 300 from inventory screen 200 via selection of the next button 242 (FIG. 2) or directly via selection of the Configure Cluster tab 302. The cluster configuration table 304 displays configuration information for one or more nodes for which Hadoop framework compatible configuration commands need to be generated as a result of the node modifications or additions made via the inventory module screen 200 (FIG. 2). By way of example, the configuration information may include a corresponding node type, IP address, and user name fields 210-214 discussed above in connection with FIG. 2. The cluster configuration table 304 also includes a status field 306 for each corresponding node. In an embodiment, the status field 306 displays “new,” “modified,” “successful,” or an “error” indicator for each corresponding node during Hadoop configuration.

Upon review of the configuration information, displayed in the cluster configuration table 304, the user selects a create configuration button 308. Selection of the create configuration button 308 causes the processor to generate Hadoop framework compatible configuration commands and automatically send these commands to corresponding nodes (e.g., distributed data and/or application computer hardware) within the selected cluster. In an embodiment, to provide a real-time feedback as to the progress of the execution of generated node configuration commands, the screen 300 includes a progress status bar 310 which provides a visual indicator of completed node configurations. For instance, the progress status bar 310 may display a solid color to indicate a fraction of completed commands based on the fraction of acknowledgments received from each node. Alternatively or in addition, the progress bar 310 may display a percentage of completed configuration commands based on the percentage of acknowledgments received from the nodes subject to configuration. The cancel button 312 initiates cancelling an ongoing cluster configuration process.

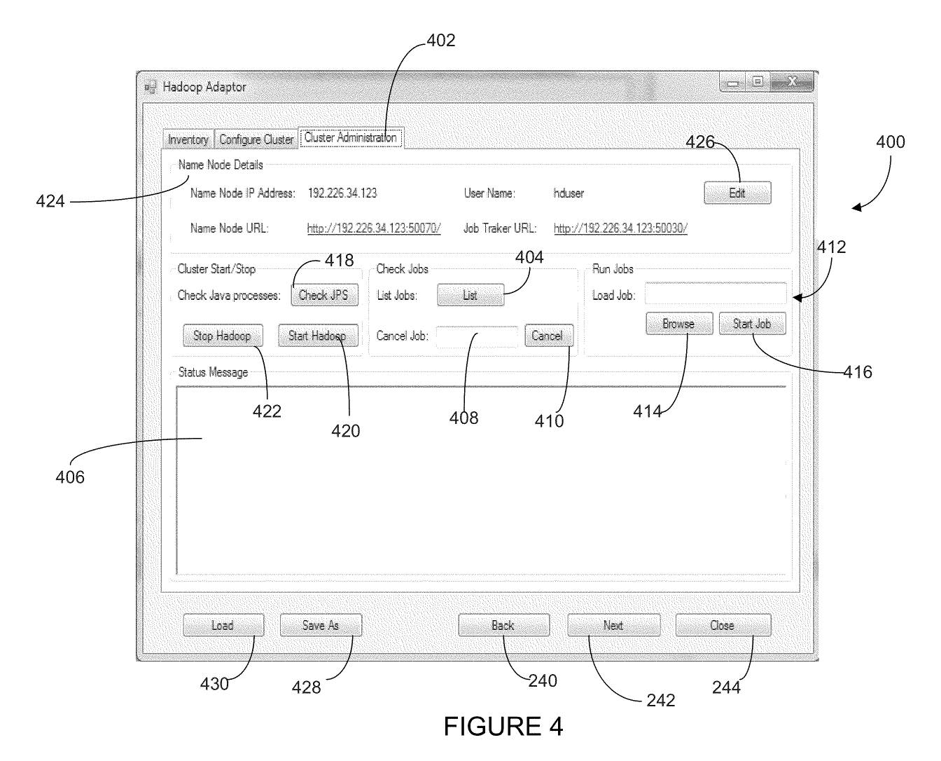

FIG. 4 illustrates an embodiment of a GUI configuration screen 400 associated with an administration module of the Hadoop adapter 105. The user navigates to the screen 400 from the previous screen 300 via the next button 242 or directly via the selection of the cluster administration tab 402, As further discussed below, the administration screen 400 provides the user with the ability to check currently running Hadoop jobs (e.g., data indexing or various other distributed computing processes), cancel currently running jobs, load new jobs, as well as start or stop the Hadoop system and check the name node details.

Specifically, the user checks currently running Hadoop jobs via the list jobs button 404. Upon selection of the list jobs button 404 the currently running jobs are displayed in the status area 406. When the user selects one or more running jobs from the status area 406, such jobs are displayed in the cancel job field 408. If the user selects the cancel button 410, the corresponding jobs are stopped or killed. In addition to cancelling jobs, the screen 400 provides the user with an interface 412 for loading previously defined jobs. In particular, the browse button 414 loads a previously defined job, while the start job button 416 starts execution of the loaded job.

Additionally, the check JPS button 418 lists the Java-specific processes associated. with Hadoop system in the status area 406. The Hadoop start and stop buttons 420, 422 provides the administrator with an interface for starting and stopping the entire Hadoop system. The name node details area 424 provides the administrator with information on name node IP address, a link to the name node Uniform Resource Locator (URL), and administrator username for the name node. In the illustrated embodiment, the name node details area 424 further includes a link to a dedicated URL for the Hadoop system job tracker. The edit button 426 initiates administrator's edits to the name node cluster in the event the administrator desires to make changes to the cluster site being monitored. Finally, the save as button. 428 saves any previous changes under a new Hadoop system name, while the load button 430 loads a new Hadoop system for administration.

Unless specifically stated otherwise as apparent from the following discussion, it is appreciated that throughout the description, discussions utilizing terms such as “processing,” “computing,” “transmitting,” “receiving,” “determining,” “displaying,” “identifying,” “presenting,” “establishing,” or the like, can refer to the action and processes of a data processing system, or similar electronic device, that manipulates and transforms data represented as physical (electronic) quantities within the system's registers and memories into other data similarly represented as physical quantities within the system's memories or registers or other such information storage, transmission or display devices. The system or portions thereof may be installed on an electronic device.

The exemplary embodiments can relate to an apparatus for performing one or more of the functions described herein. This apparatus may be specially constructed for the required purposes and/or be selectively activated or reconfigured by computer executable instructions stored in non-transitory computer memory medium.

It is to be appreciated that the various components of the technology can be located at distant portions of a distributed network and/or the Internet, or within a dedicated secured, unsecured, addressed/encoded and/or encrypted system. Thus, it should be appreciated that the components of the system can be combined into one or more devices or co-located on a particular node of a distributed network, such as a telecommunications network. As will be appreciated from the description, and for reasons of computational efficiency, the components of the system can be arranged at any location within a distributed network without affecting the operation of the system. Moreover, the components could be embedded in a dedicated machine.

Furthermore, it should be appreciated that the various links connecting the elements can be wired or wireless links, or any combination thereof or any other known or later developed element(s) that is capable of supplying and/or communicating data to and from the connected elements. The term “module” as used herein can refer to any known or later developed hardware, software, firmware, or combination thereof that is capable of performing the functionality associated with that element.

All references, including publications, patent applications, and patents, cited. herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value failing within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Presently preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A system for administration of a Hadoop distributed computing network comprising:
a Hadoop cluster comprising at least one name node computer and a plurality of data node computers;
an administration computer comprising a processor and computer readable memory having stored thereon computer executable instructions for implementing a Hadoop adapter configured to receive user input and convert the user input into computer executable instructions for administering the Hadoop cluster; and
a graphical user interface configured to provide the user input to the Hadoop adapter of the administration computer, the graphical user interface comprising:
an inventory module configured to receive the user input for administering the Hadoop cluster,
a configuration module configured to communicate the computer executable instructions for administering the Hadoop cluster to at least one of the name node computer and one or more data node computers and provide a visual indication of a configuration status of the at least one of the name node computer and the one or more data node computers, and
an administration module configured to provide status with respect to one or more computer executable processes associated with the Hadoop cluster.

2. The system of claim 1 wherein the graphical user interface further comprises a plurality of elements for at least one of loading, modifying, and creating the Hadoop cluster.

3. The system of claim 2 wherein the plurality of elements includes a drop down list for selecting the Hadoop cluster among a plurality of Hadoop clusters.

4. The system of claim 2 wherein the plurality of elements includes a cluster details table comprising editable fields corresponding to one or more of node IP address, node type, administrator credentials, and node data storage location.

5. The system of claim 2 wherein the plurality of elements includes a cluster configuration table comprising a configuration status field corresponding to each node in the Hadoop cluster,

6. The system of claim 1 wherein the visual indication comprises a status bar indicative of a progress of completed node configurations.

7. The system of claim 1 wherein the graphical user interface is configured to receive user input for managing the one or more computer executable processes associated with the Hadoop cluster.

8. A method of administering a Hadoop distributed computing network via a computer implemented graphical user interface, the method comprising:
receiving, via the computer implemented graphical user interface, user input for administering a Hadoop cluster comprising a name node computer and a plurality of data node computers;
transforming the user input into computer executable instructions for administering the Hadoop cluster and storing said instructions in non-transitory computer readable medium;
communicating the computer executable instructions for administering the Hadoop cluster to at least one of the name node computer and one or more data node computers;
providing, via the computer implemented graphical user interface, a visual indication of a configuration status of the at least one name node computer and the one or more data node computers; and
providing, via the computer implemented graphical user interface, a status with respect to one or more computer executable processes associated with the Hadoop cluster.

9. The method of claim 8 wherein the graphical user interface further comprises a plurality of elements for at least one of loading, modifying, and creating the Hadoop cluster.

10. The method of claim 9 wherein the plurality of elements includes a drop down list for selecting the Hadoop cluster among a plurality of Hadoop clusters.

11. The method of claim 9 wherein the plurality of elements includes a cluster details table comprising editable fields corresponding to one or more of node IP address, node type, administrator credentials, and node data storage location.

12. The method of claim 9 wherein the plurality of elements includes a cluster configuration table comprising a configuration status field corresponding to each node in the Hadoop cluster.

13. The method of claim 8 wherein the visual indication comprises a status bar indicative of a progress of completed node configurations.

14. The method of claim 8 wherein the user input further comprises an input for managing the one or more computer executable processes associated with the Hadoop cluster,

15. A non-transitory computer readable medium having stored thereon computer executable instructions for administering a Hadoop distributed computing network via a graphical user interface, the instructions comprising:
receiving user input for administering a Hadoop cluster comprising a name node computer and a plurality of data node computers;
transforming the user input into computer executable instructions for administering the Hadoop cluster;
communicating the computer executable instructions for administering the Hadoop cluster to at least one of the name node computer and one or more data node computers;
providing a visual indication of a configuration status of the at least one name node computer and the one or more data node computers; and
providing a status with respect to one or more computer executable processes associated with the Hadoop cluster.

16. The computer readable medium of claim 15 wherein the instructions further comprise providing a plurality of elements for the graphical user interface, the plurality of elements configured to relay user input for at least one of loading, modifying, and creating the Hadoop cluster.

17. The computer readable medium of claim 16 wherein the plurality of elements includes a drop down list for selecting the Hadoop cluster among a plurality of Hadoop clusters.

18. The computer readable medium of claim 16 wherein the plurality of elements includes a cluster details table comprising editable fields corresponding to one or more of node IP address, node type, administrator credentials, and node data storage location.

19. The computer readable medium of claim 16 wherein the plurality of elements includes a cluster configuration table comprising a configuration status field corresponding to each node in the Hadoop cluster.

20. The computer readable medium of claim 15 wherein the visual indication comprises a status bar indicative of a progress of completed node configurations.

21. The computer readable medium of claim 15 wherein the user input further comprises an input for managing the one or more computer executable processes associated with the Hadoop cluster.
